(19) United States
(12) Patent Application Publication
(10) Pub. No.: US 2015/0212229 A1
(43) Pub. Date: Jul. 30, 2015

(54) X-RAY INSPECTION DEVICE AND MEANS FOR TRIGGERING ACTIVATION OF SAME

(71) Applicant: EXELON GENERATION COMPANY, LLC, Kenneth Square, PA (US)

(72) Inventor: James W. Walcher, Wilmington, IL (US)

(21) Appl. No.: 14/418,742

(22) PCT Filed: Jul. 31, 2013
(86) PCT No.: PCT/US13/52962

§ 371 Date: Jan. 30, 2015

Related U.S. Application Data
(60) Provisional application No. 61/677,785, filed on Jul. 31, 2012.

(51) Int. Cl. G01V 5/00; G01N 23/04

(52) U.S. Cl. CPC G01V 5/0016; G01N 23/04

(57) ABSTRACT

An X-ray inspection device including means for ensuring complete imaging of every article that passes through the X-ray inspection device. Methods of using the X-ray inspection device are also described.

### CROSS-REFERENCE TO RELATED APPLICATION

This application claims the benefit of the filing date of U.S. Provisional Patent Application No. 61/677,785, filed Jul. 31, 2012, which is incorporated by reference herein in its entirety.

### FIELD

This application relates generally to the X-ray screening of baggage and other items and, more particularly, to X-ray screening systems that ensure that all items passing through the system are properly imaged.

### BACKGROUND

X-ray systems are conventionally used in a variety of applications for purposes of inspecting baggage and other items that are carried by individuals as they enter a secured area. Exemplary applications of such X-ray systems include building security screenings and airport security screenings.

During typical uses of conventional X-ray screening systems, individuals position their baggage and other belongings in a bin that is transported through the X-ray screening system. Such conventional X-ray screening systems are effective at screening the majority of the objects positioned within the bins. However, the X-ray screening systems often fail to image portions of objects that hang over the edges of the bin. Thus, during typical usage, conventional X-ray screening systems often do not provide a complete X-ray image of the objects passing through the screening system. These limitations raise serious concerns for those who rely on X-ray screening systems for security and safety.

Accordingly, there is a need in the pertinent art for X-ray screening systems that reliably provide complete X-ray images of every object that passes through the screening systems.

### SUMMARY

Described herein is an X-ray inspection device having one or more trigger doors. The X-ray inspection device can include a conveyor belt configured for movement relative to a transport axis. The conveyor belt can be configured to support the article and transport the article relative to the transport axis. The X-ray inspection device can also include a housing having a longitudinal axis and defining an inspection chamber having an entrance and an exit. A portion of the conveyor belt can be positioned within the inspection chamber such that the transport axis of the conveyor belt is substantially parallel to the longitudinal axis of the housing. The X-ray inspection device can further include an X-ray emission tube and a sensor for detecting the presence of an article within the inspection chamber. Upon activation, the X-ray emission tube can be configured to emit X-rays toward the conveyor belt within the inspection chamber of the housing. The sensor can be operatively coupled to the X-ray emission tube such that, upon triggering of the sensor, the X-ray emission tube is activated. The X-ray inspection device can still further include one or more trigger doors pivotally coupled to the housing proximate the entrance to the inspection chamber. Each trigger door can be configured for pivotal movement about and between a closed position and an open position. Upon contact between the one or more trigger doors and an article positioned on the conveyor belt, the trigger doors are configured to move to the open position, thereby triggering the sensor and activating the X-ray emission tube to ensure generation of an X-ray image that depicts the entirety of each article that passes through the X-ray inspection device. Also described is a trigger door assembly that can be retro-fit to conventional X-ray inspection devices.

Also described herein is a method of inspecting the contents of an article using the described X-ray inspection device. The method of inspecting the contents of the article can include positioning the article on the conveyor belt and selectively activating the conveyor belt such that the article is transported relative to the transport axis. The article can be transported relative to the transport axis such that the article contacts and passes through the one or more trigger doors, thereby triggering the sensor and activating the X-ray emission tube. The method of inspecting the contents of the article can further include generating an X-ray image of the article.

### BRIEF DESCRIPTION OF THE DRAWINGS

These and other features of the preferred embodiments of the invention will become more apparent in the detailed description in which reference is made to the appended drawings wherein:

FIG. 1 is a perspective view of an exemplary X-ray inspection device as described herein.

FIG. 2 is a front perspective view of an exemplary X-ray inspection device having a single trigger door hinged from a top portion of the X-ray inspection device, as described herein.

FIG. 3 is a partially transparent side view of the X-ray inspection device of FIG. 2 showing the movement pathway of the trigger door as an object is passed through the X-ray inspection device, as described herein.

FIG. 4 is an isolated front perspective view of the single trigger door of FIG. 2.

FIG. 5 is a front perspective view of an exemplary X-ray inspection device having two opposed trigger doors hinged from respective side portions of the X-ray inspection device, as described herein.

FIGS. 6 and 7 are isolated front perspective views of the two opposed trigger doors of FIG. 5.

FIGS. 8A and 8B are partially transparent side views of the X-ray inspection device of FIG. 5 showing the movement pathway of the trigger doors as an article is passed through the X-ray inspection device, as described herein. FIG. 8A depicts the trigger doors in a closed position, while FIG. 8B depicts the trigger doors in an open position.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a trigger door” can include two or more such trigger doors unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The word “or” as used herein means any one member of a particular list and also includes any combination of members of that list.

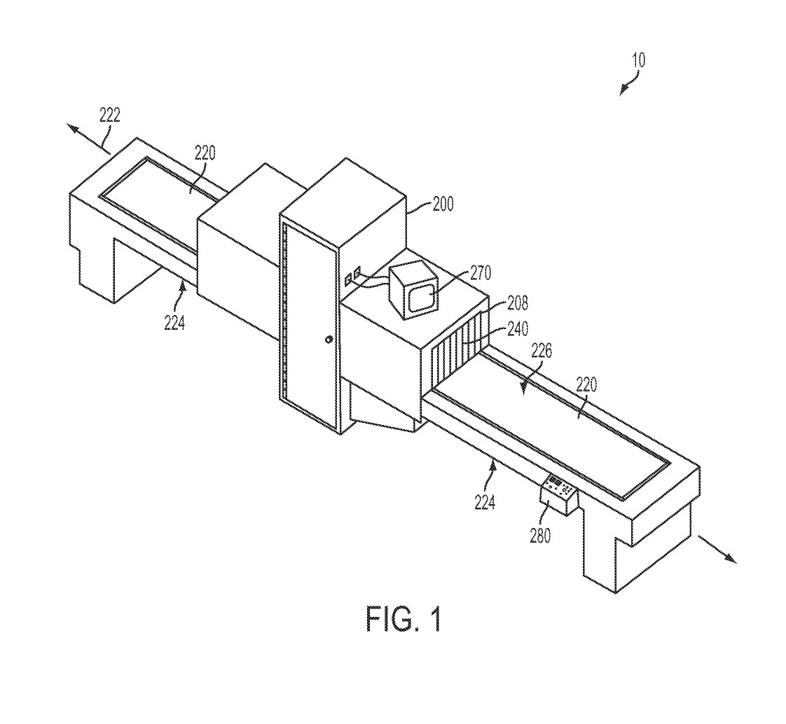

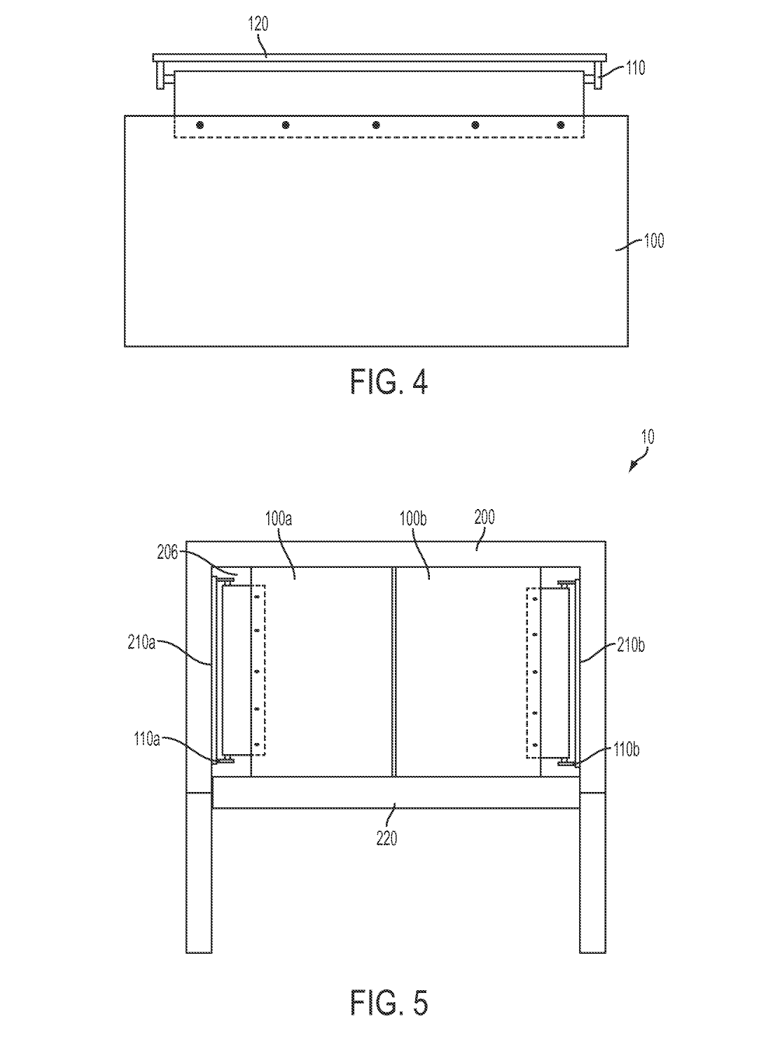

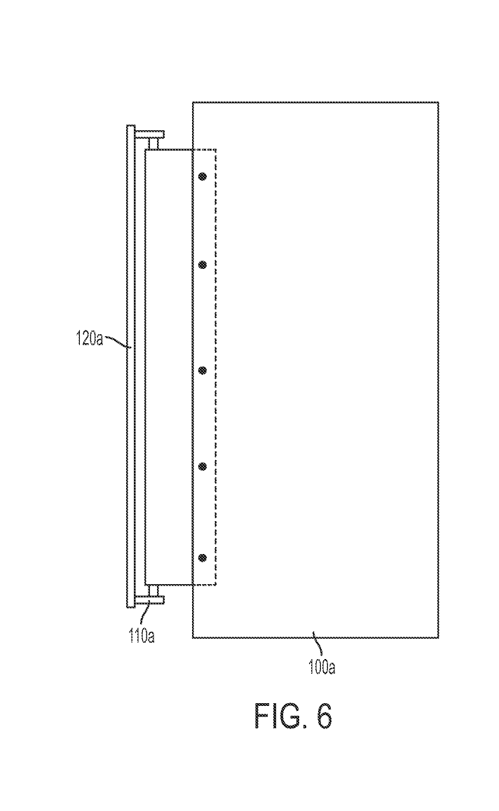

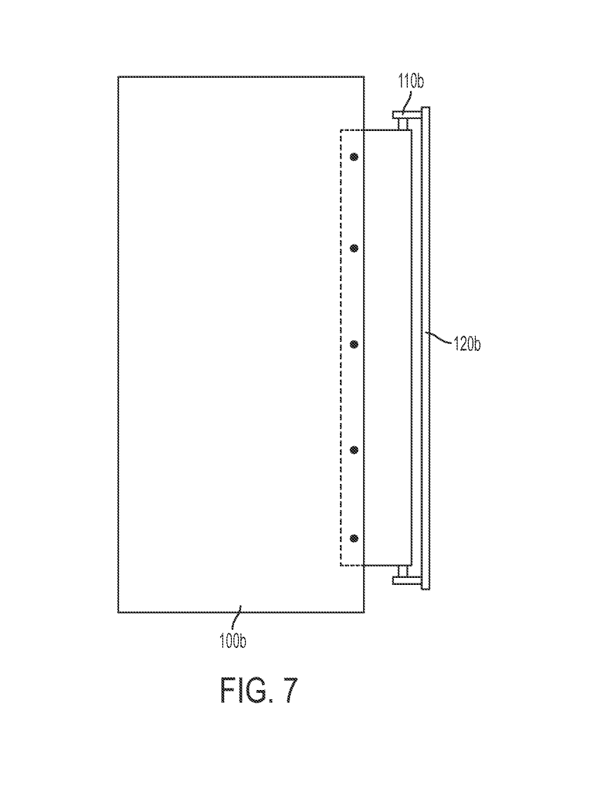

Disclosed herein are devices, systems, and methods of using electromagnetic radiation to inspect the contents of an article or plurality of articles, such as, for example and without limitation, bags, luggage, purses, and other personal items and effects. In exemplary aspects, and as further described herein, the disclosed devices, systems, and methods can use X-radiation to inspect the contents of such articles. In these aspects, it is contemplated that the X-radiation can comprise X-rays having a wavelength ranging from about 0.01 nm to about 10 nm. For example, as described herein with reference to FIGS. 1-8, an inspection device 10 for inspecting the contents of an article (or a plurality of articles) can be provided with the ability to emit X-radiation. It is contemplated that the inspection device 10 can comprise any components and features of conventional X-ray inspection devices and systems that do not affect the functionality of the image-triggering mechanisms described herein. Although the inspection device 10 is described below as an X-ray inspection device having an X-ray emission tube, it is understood that, in alternative exemplary aspects, the inspection device can be configured to emit electromagnetic radiation of any frequency, including frequencies falling above or below the conventional frequency range for X-radiation.

In exemplary aspects, the X-ray inspection device 10 can comprise a housing 200 (for example and without limitation, a lead-shielded housing) having an X-ray tube 250, an inspection chamber 204, and a camera assembly 290. As shown in FIGS. 1-3, 5, and 8, the X-ray inspection device 10 can be provided with an automatic conveyor belt 220 which moves baggage, products, and other items to be inspected into and out of the inspection chamber 204 at a variable continuous slow speed. It is contemplated that the items to be inspected can be transported through one or more trigger doors 100 (as further described herein) as they enter into the inspection chamber 204 and then through flexible shielded exit curtains 240 as they exit the inspection chamber. Optionally, it is contemplated that the X-ray inspection device 10 can comprise flexible shielded entrance curtains (not shown) through which the items to be inspected pass prior to engagement with the one or more trigger doors 100. A conventional sensor 260 can be provided at the entrance 206 of the inspection chamber 204 to sense the presence and/or movement of the objects as they pass into the inspection chamber and to activate the X-ray emission tube 250 to emit X-rays for purposes of imaging the objects placed on the conveyor belt 220. As used herein, the term “sensor” refers to any conventional sensor that is configured to detect the presence and/or movement of an article within a selected region of the inspection chamber of the X-ray inspection device. Exemplary sensors include conventional mechanical sensors and conventional optical sensors, such as, for example and without limitation, photoelectric sensors. In exemplary aspects, the sensor 260 can be a photoelectric eye switch.

It is contemplated that the X-ray emission tube 250 can be shielded using conventional means. It is further contemplated that the X-ray emission tube 250 can be mounted on spaced supports so that its radiation collimation orifice is centered with respect to a central opening in a shielded focal member. The shielded focal member, such as of lead-shielded plywood, can be configured to prevent any X-rays from leaving the X-ray tube 250 except through a port or the central opening, and the size of the central opening and its position relative to the X-ray tube 250 and a fluoroscopic screen can produce a divergent beam of radiation which strikes only the fluoroscopic screen (and strikes substantially the entire top surface thereof).

It is further contemplated that the X-ray tube 250 can further comprise an X-ray controller, which is associated with the sensor 260 for activating the X-ray tube. It is still further contemplated that the X-ray controller can comprise a timer for deactivating the X-ray tube 250 a predetermined period of time after the eye beam is restored by passage of the article being inspected.

It is still further contemplated that the inspection chamber 204 of the X-ray inspection device can comprise a central exposure section and an associated entrance section 206 and exit section 208. The sensor 260 can be provided at the entrance 206 of the inspection chamber 204. It is contemplated that the entrance and exit sections 206, 208 can be provided to accommodate elongate articles being inspected. It is further contemplated that lead-shielded flexible curtain banks (such as, for example, exit curtains 240) can be provided to permit articles to be conveyed to and from the inspection chamber 204 while not permitting any of the low intensity X-rays to escape. In most cases the article being inspected, such as a luggage article, will be completely within the inspection chamber 204 before the X-ray tube 250 is activated and the latter will be deactivated before the article reaches the interior exit curtain 240. However, even if an elongate article or a succession of smaller articles is conveyed through the shielded inspection chamber 204, it is contemplated that the flexibility of the banks of shielded curtains can permit them to conform closely to the surface of the articles, and to close between articles, so that no radiation can escape. It is further contemplated that the low intensity of the radiation and the distance between the central exposure section of the inspection chamber 204 and the outermost curtains can preclude any danger of harmful exposure of the inspector to radiation.

Optionally, the ceiling of the inspection chamber 204 can comprise the shielded focal member of the X-ray tube 250 while the floor of the inspection chamber can comprise the fluoroscopic screen which supports the object being conveyed on the belt 220. It is contemplated that the fluoroscopic screen can comprise leaded glass to provide a barrier against the passage of the X-rays, whereby an underlying camera assembly 290 need not be shielded. However, in exemplary aspects, a floor or table, which is coplanar with the screen and supports the conveyor belt 220 in all areas, except within the central exposure section of the inspection chamber 204, must be shielded insofar as it is located within the entrance section 206 and exit section 208 of the inspection chamber and between the outermost curtains.

Optionally, the camera assembly 290 can comprise the shielded fluoroscopic screen as its ceiling, a mirror supported at an angle with respect to the fluoroscopic screen and a camera (such as, for example and without limitation, a television camera) supported at an angle and distance relative to the mirror whereby the camera can detect or “see” a reflected image corresponding to the entire undersurface of the fluoroscopic screen. It is contemplated that the mirror can permit the camera to be spaced further from the fluoroscopic screen so that the entire screen can be exposed to the camera.

It is contemplated that the camera assembly 290 can optionally be provided with a special secondary signal booster which increases the sensitivity of the camera and the strength of the signal current transmitted by the camera to a receiver or monitor 270. In exemplary aspects, the camera assembly 290 can comprise a cathode ray tube. It is contemplated that the secondary signal booster, also referred to as an emission multiplier or photomultiplier tube, can provide at least a 1,000 times gain and preferably a 50,000 times gain in signal strength and thus convert the weak, low-intensity X-ray image, which is present on the fluoroscopic screen and is difficult or impossible to discern with the naked eye, into greatly intensified image signals which are transmitted to the monitor 270 to form a sharp, clear, intensified picture on the monitor screen.

As shown in FIG. 1, the conveyor system for moving articles to be inspected into and out of the inspection chamber 204 can comprise support housings 224 which support the table and the continuous conveyor belt 220, which moves over the table as it carries articles into and out of the inspection chamber and returns under the table. Optionally, it is contemplated that the drive and support mechanism for the continuous belt 220 can comprise a drive roller in a first support housing, spaced idler rollers and a support roller rotatably mounted in a second support housing. It is further contemplated that the drive roller can be driven by a variable speed motor, mounted within the first support housing, in association with a drive belt. Optionally, the motor can be electrically connected to a control panel 280 and can be adapted for normal continuous operation at any desired slow speed. However, it is contemplated that the control panel 280 can comprise manual override switch means whereby the speed of the motor can be varied, or the motor may be stopped and reversed by the operator as may be required during the inspection operation.

In exemplary aspects, it is contemplated that the X-ray inspection device 10 can comprise a computer having a processor in operative communication with one or more of the following elements according to conventional methods and techniques: the conveyor belt 220; the X-ray tube 250; the sensor 260; the monitor 270; the control panel 280; and the camera assembly 290. In these aspects, it is contemplated that the computer can be used to selectively control the operation of one or more of the conveyor belt 220, the X-ray tube 250, the sensor 260, the monitor 270, the control panel 280, and the camera assembly 290. In further exemplary aspects, it is contemplated that the processor can be configured to receive one or more input signals. In these aspects, it is contemplated that the processor can be configured to adjust the operation of one or more of the conveyor belt 220, the X-ray tube 250, the sensor 260, the monitor 270, the control panel 280, and the camera assembly 290 in response to the one or more input signals.

It is contemplated that the sensor 260 can be positioned at a selected height relative to a top surface 226 of the conveyor belt 220. In exemplary aspects, it is contemplated that the sensor 260 can be positioned proximate the top surface 226 of the conveyor belt 220. In these aspects, it is further contemplated that, due to the positioning of the sensor 260 proximate the top surface 226 of the conveyor belt 220, the sensor can be configured to detect only those objects and articles positioned within the first few inches of the top surface of the conveyor belt. Conventionally, in such an arrangement, articles that (a) extend out of a bin at a height of greater that about 3 to 4 inches (relative to the top surface of the conveyor belt) or that (b) are shaped such that an edge portion of the article is spaced from the top surface of the conveyor belt by about 3 to 4 inches are not immediately detected by such a sensor 260. Consequently, in conventional X-ray inspection devices, it is contemplated that the portions of these articles that are not detected by the sensor may not be properly imaged by the X-ray inspection device. That is, because the sensor does not initially detect the presence of the article, the X-ray imaging of the article is not initiated in time to capture the portions of the article that were not detected by the sensor.

In order to address these failures, in exemplary aspects, the one or more trigger doors 100 of the X-ray inspection device 10 disclosed herein can be configured to ensure that the sensor 260 is triggered upon entry of an article into the inspection chamber 204 of the X-ray inspection device. In these aspects, the one or more trigger doors 100 can be positioned and shaped such that, as the trigger doors open, at least one trigger door passes within a detection zone of the sensor 260 (within the area of the inspection chamber 204 in which the sensor can detect the presence of an article). Thus, it is contemplated that the one or more trigger doors 100, upon opening, can be configured to pass within about 2 to 3 inches of the top surface 226 of the conveyor belt 220 at a position within the X-ray inspection device 10 that is substantially aligned with the sensor 260.

In one aspect, the conveyor belt 220 of the X-ray inspection device 10 can be configured for movement relative to a transport axis 222. In these aspects, it is contemplated that the conveyor belt 220 can be configured to support the article and transport the article relative to the transport axis 222.

In another aspect, the housing 200 of the X-ray inspection device 10 can have a longitudinal axis 202 and define the inspection chamber 204. It is contemplated that the inspection chamber can have an entrance 206 and an exit 208. It is further contemplated that a portion of the conveyor belt 220 can be positioned within the inspection chamber 204 such that the transport axis 222 of the conveyor belt is substantially parallel to the longitudinal axis 202 of the housing 200. Optionally, the transport axis 222 of the conveyor belt can be substantially axially aligned with the longitudinal axis 202 of the housing 200.

In a further aspect, the X-ray emission tube 250, upon activation, can be configured to emit X-rays toward the conveyor belt 220 within the inspection chamber 204 of the housing 200. In still another aspect, the sensor 260 can be operatively coupled to the X-ray emission tube 250 such that, upon triggering of the sensor 260, the X-ray emission tube is activated.

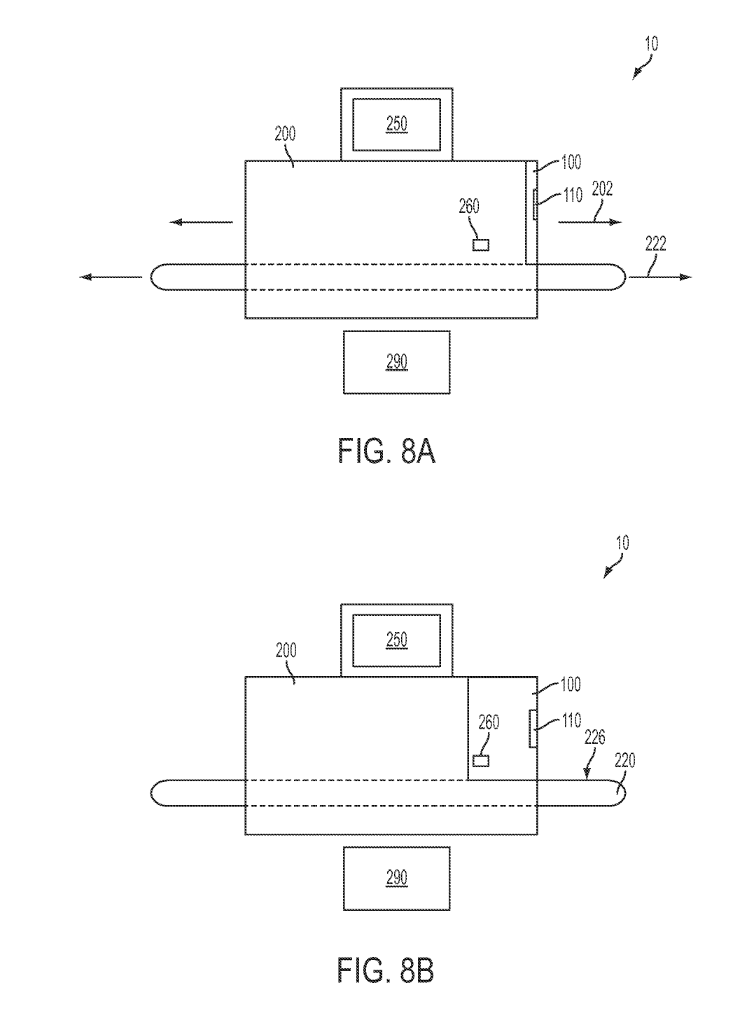

In another aspect, the one or more trigger doors 100 can be pivotally coupled to the housing 200 proximate the entrance 206 to the inspection chamber 204. In this aspect, each trigger door 100 of the one or more trigger doors can be configured for pivotal movement about and between a closed position (See FIGS. 3 and 8A) and an open position (See FIG. 8B). Upon contact between the one or more trigger doors 100 and the article (as it is transported by the conveyor belt 220), each trigger door of the one or more trigger doors can be configured to move to the open position. It is further contemplated that, in the open position, at least one trigger door 100 of the one or more trigger doors can be configured to trigger the sensor 260, thereby activating the X-ray emission tube 250. In exemplary aspects, in the open position, at least a portion of at least one trigger door 100 of the one or more trigger doors can be positioned within the detection zone of the sensor 260.

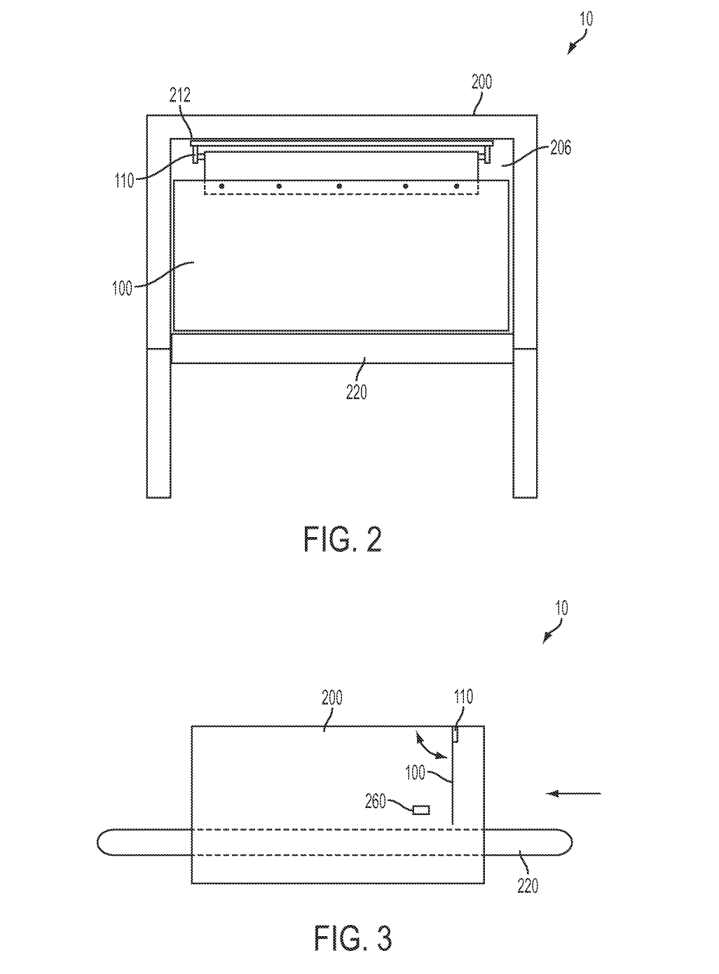

In an additional aspect, as shown in FIGS. 2 and 5, the entrance 206 to the inspection chamber 204 can be defined by opposed first and second side portions 210a, 210b of the housing 200 and a top portion 212 of the housing extending between the first and second side portions.

As shown in FIGS. 2-4, in one aspect, the one or more trigger doors can comprise a single trigger door 100 that is secured to a portion of the housing 200 of the X-ray inspection device 10. Optionally, it is contemplated that the trigger door 100 can be hingedly attached to the housing 200. For example, the trigger door 100 can be hingedly attached to the housing 200 using a self-centering gravity hinge 110. It is further contemplated that the trigger door 100 can be hingedly attached to the housing 200 of the X-ray inspection device 10 such that the trigger doors open inwardly along the direction of movement of the conveyor belt 220 (and the articles placed on the conveyor belt). It is still further contemplated that the trigger door 100 can be shaped to substantially fill the entrance (opening) 206 of the inspection chamber 204 of the housing 200 of the X-ray inspection device 10 when the trigger door is positioned in a closed position. It is still further contemplated that the hinges 110 of the trigger door 100 can be biased such that, following opening the trigger door, the trigger door is biased to return to the closed position. Optionally, the trigger door 100 can be attached to a side portion 210 of the housing 200 of the X-ray inspection device 10. However, as illustrated in FIGS. 2-4, it is also contemplated that the trigger door can be attached to the top portion 212 of the housing 200 of the X-ray inspection device 10.

As shown in FIGS. 5-8, in one aspect, the one or more trigger doors can comprise opposed first and second trigger doors 100a, 100b that are secured to the respective side portions 210a, 210b of the housing 200 of the X-ray inspection device 10. In this aspect, it is contemplated that the trigger doors 100a, 100b can be hingedly attached to the side portions 210a, 210b of the housing 200 of the X-ray inspection device 10. It is further contemplated that the trigger doors 100a, 100b can be hingedly attached to the side portions 210a, 210b of the housing 200 of the X-ray inspection device 10 such that the trigger doors open inwardly along the direction of movement of the conveyor belt 220 (and the articles placed on the conveyor belt). In exemplary aspects, the trigger doors 100a, 100b can be saloon-type doors. It is further contemplated that the trigger doors 100a, 100b can be shaped to substantially fill the entrance (opening) 206 of the inspection chamber 204 of the housing 200 of the X-ray inspection device 10 when the trigger doors are positioned in a closed position. It is further contemplated that the hinges 110 of the trigger doors 100a, 100b can be biased such that, following opening the trigger doors, the trigger doors are biased to return to the closed position.

In use, as an article enters into the X-ray inspection device 10, the article necessarily contacts the one or more trigger doors 100. As the article moves with the conveyor belt 220 through the X-ray inspection device 10, the one or more trigger doors 100 are pivotally advanced in the direction of movement of the article. During this movement of the one or more trigger doors 100, the doors pass in front of (within the detection zone of) the sensor 260, thereby triggering the activation of the X-ray emission tube 250 and ensuring that all portions of the article are properly imaged. Thus, in exemplary aspects, a method of inspecting the contents of the article can comprise positioning the article on the conveyor belt 220 and selectively activating the conveyor belt such that the article is transported relative to the transport axis 222. In these aspects, the article can be transported relative to the transport axis 222 such that the article contacts and passes through the one or more trigger doors 100. In further exemplary aspects, the method of inspecting the contents of the article can comprise generating an X-ray image of the article.

In exemplary aspects, it is contemplated that the one or more trigger doors 100 can be provided as a trigger door assembly which can be retro-fit to existing X-ray inspection devices. In these aspects, it is contemplated that the one or more trigger doors 100 can be secured to a conventional X-ray inspection device 10 in the manner disclosed herein in order to ensure complete imaging of every article that passes through the X-ray inspection device. Thus, in some exemplary aspects, it is contemplated that the one or more trigger doors 100 can be secured to the housing 200 in an operative position. In these aspects, it is contemplated that, when the one or more trigger doors are secured in the operative position, the one or more trigger doors 100 are positioned relative to the sensor 260 such that, upon opening of the trigger doors (i.e., pivotal movement of the trigger doors to the open position), at least one trigger door will trigger the sensor as disclosed herein. In exemplary aspects, it is contemplated that the one or more trigger doors 100 can be secured to at least one side portion 210 of the housing 200 in the operative position. In other exemplary aspects, it is contemplated that the one or more trigger doors 100 can be secured to the top portion 210 of the housing 200 in the operative position.

Optionally, it is contemplated that the trigger door assembly can further comprise one or more support posts 120 that are operatively coupled to the one or more trigger doors 100 and that are configured for secure attachment to a free-standing X-ray inspection device.

It is contemplated that the one or more trigger doors 100 can comprise any conventional solid material. Optionally, it is contemplated that the one or more trigger doors 100 can comprise a plastic material. In exemplary aspects, the one or more trigger doors 100 can comprise one or more polycarbonate resin thermoplastic materials.

Similarly, it is contemplated that the hinges 110 can comprise any conventional solid material. Optionally, it is contemplated that the hinges 110 can comprise a plastic material. In exemplary aspects, the hinges 110 can comprise one or more polycarbonate resin thermoplastic materials.

It is further contemplated that the support posts 120 can comprise any conventional solid material. Optionally, it is contemplated that the one or more support posts 120 can comprise a plastic material. In exemplary aspects, the one or more support posts 120 can comprise one or more polycarbonate resin thermoplastic materials.

In further exemplary aspects, it is contemplated that a trigger door 100 and its corresponding hinges 110 can be provided as a unitary (one-piece) construct. In these aspects, it is contemplated that the trigger door 100 and its hinges 110 can be formed of the same material(s). In further exemplary aspects, it is contemplated that a trigger door 100 and its corresponding hinges 110 and support posts 120 can be provided as a unitary (one-piece) construct. In these aspects, it is contemplated that the trigger door 100 and its hinges 110 and support posts 120 can be formed of the same material(s). In still further exemplary aspects, it is contemplated that a hinge 110 and a corresponding support post 120 can be provided as a unitary (one-piece) construct. In these aspects, it is contemplated that the unitary hinge-support post construct can be configured for secure attachment to a corresponding trigger door 100.

In exemplary aspects, disclosed herein is an X-ray inspection device for inspecting the contents of an article, comprising: a conveyor belt configured for movement relative to a transport axis, the conveyor belt being configured to support the article and transport the article relative to the transport axis; a housing having a longitudinal axis and defining an inspection chamber having an entrance and an exit, a portion of the conveyor belt being positioned within the inspection chamber such that the transport axis of the conveyor belt is substantially parallel to the longitudinal axis of the housing; an X-ray emission tube, wherein, upon activation, the X-ray emission tube is configured to emit X-rays toward the conveyor belt within the inspection chamber of the housing; a sensor configured to detect the presence of the article within the inspection chamber, the sensor being operatively coupled to the X-ray emission tube such that, upon triggering of the sensor, the X-ray emission tube is activated; and one or more trigger doors pivotally coupled to the housing proximate the entrance to the inspection chamber, each trigger door of the one or more trigger doors being configured for pivotal movement about and between a closed position and an open position, wherein, upon contact between the one or more trigger doors and the article, each trigger door of the one or more trigger doors is configured to move to the open position, and wherein at least one trigger door of the one or more trigger doors is shaped to trigger the sensor when the one or more trigger doors are positioned in the open position, thereby activating the X-ray emission tube.

In another exemplary aspect, the sensor is a photoelectric eye switch.

In another exemplary aspect, the sensor has a detection zone, wherein the sensor is configured to detect the presence of an article within the detection zone, and, in the open position, at least a portion of at least one trigger door of the one or more trigger doors is positioned within the detection zone.

In another exemplary aspect, the entrance to the inspection chamber is defined by opposed first and second side portions of the housing and a top portion of the housing extending between the first and second side portions.

In another exemplary aspect, the one or more trigger doors comprises a single trigger door secured to the top portion of the housing.

In another exemplary aspect, the one or more trigger doors comprises a single trigger door secured to one of the first and second side portions of the housing.

In another exemplary aspect, the one or more trigger doors comprises opposed first and second trigger doors respectively secured to the opposed first and second side portions of the housing.

In another exemplary aspect, the one or more trigger doors are hingedly attached to the housing.

In another exemplary aspect, during movement from the closed position to the open position, the one or more trigger doors are configured to open inwardly in the direction of movement of the article relative to the transport axis.

In another exemplary aspect, the one or more trigger doors are biased to return to the closed position.

In another exemplary aspect, the one or more trigger doors are shaped to substantially fill the entrance to the inspection chamber of the housing.

In other exemplary aspects, disclosed herein is a trigger door assembly for triggering a sensor of an X-ray inspection device during inspection of an article, the X-ray inspection device having a housing defining an inspection chamber defining an entrance and an exit, and an X-ray emission tube operatively coupled to the sensor, the sensor being configured to detect the presence of the article within the inspection chamber, the trigger door assembly comprising: one or more trigger doors, each trigger door of the one or more trigger doors being configured for pivotal coupling to the housing of the X-ray inspection device proximate the entrance to the inspection chamber, wherein each trigger door of the one or more trigger doors is configured for pivotal movement about and between a closed position and an open position, wherein, upon contact between the one or more trigger doors and the article, each trigger door of the one or more trigger doors is configured to move to the open position, and wherein at least one trigger door of the one or more trigger doors is shaped to trigger the sensor when the one or more trigger doors are positioned in the open position, thereby activating the X-ray emission tube.

In another exemplary aspect, the one or more trigger doors comprises a single trigger door, and the single trigger door is configured to be pivotally coupled to a top portion of the housing.

In another exemplary aspect, the one or more trigger doors comprises a single trigger door, and the single trigger door is configured to be pivotally coupled to a side portion of the housing.

In another exemplary aspect, the one or more trigger doors comprises opposed first and second trigger doors, and the first and second trigger doors are configured to be pivotally coupled to opposing first and second side portions of the housing.

In another exemplary aspect, the one or more trigger doors comprise respective hinges, and the hinges of the one or more trigger doors are configured to pivotally couple the one or more trigger doors to the housing.

In another exemplary aspect, the article is configured for movement relative to a transport axis, and, during movement from the closed position to the open position, the one or more trigger doors are configured to open inwardly in the direction of movement of the article relative to the transport axis.

In another exemplary aspect, the one or more trigger doors are configured to be biased to return to the closed position.

In still further exemplary aspects, disclosed herein is a method of inspecting the contents of an article using an X-ray inspection device, comprising: positioning the article on a conveyor belt, the conveyor belt configured for movement relative to a transport axis, a portion of the conveyor belt being positioned within an inspection chamber defined by a housing of the X-ray inspection device, the housing having a longitudinal axis, the conveyor belt being positioned within the inspection chamber such that the transport axis is substantially parallel to the longitudinal axis of the housing, the X-ray inspection device having one or more trigger doors pivotally coupled to the housing proximate an entrance to the inspection chamber, each trigger door of the one or more trigger doors being configured for pivotal movement about and between a closed position and an open position; and selectively activating the conveyor belt such that the article is transported relative to the transport axis, wherein the article is transported relative to the transport axis such that the article contacts and passes through the one or more trigger doors, wherein each trigger door of the one or more trigger doors is configured to move to the open position as the article contacts and passes through the one or more trigger doors, wherein, in the open position, at least one trigger door of the one or more trigger doors is shaped to trigger a sensor of the X-ray inspection device when the one or more trigger doors are positioned in the open position, the sensor being operatively coupled to an the X-ray emission tube of the X-ray inspection device and configured to detect the presence of the article within the inspection chamber, and wherein, upon triggering of the sensor, the X-ray emission tube is activated.

In another exemplary aspect, the method further comprises generating an X-ray image of the article.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. An X-ray inspection device for inspecting the contents of an article, comprising:
a conveyor belt configured for movement relative to a transport axis, the conveyor belt being configured to support the article and transport the article relative to the transport axis;
a housing having a longitudinal axis and defining an inspection chamber having an entrance and an exit, a portion of the conveyor belt being positioned within the inspection chamber such that the transport axis of the conveyor belt is substantially parallel to the longitudinal axis of the housing;
an X-ray emission tube, wherein, upon activation, the X-ray emission tube is configured to emit X-rays toward the conveyor belt within the inspection chamber of the housing;
a sensor configured to detect the presence of the article within the inspection chamber, the sensor being operatively coupled to the X-ray emission tube such that, upon triggering of the sensor, the X-ray emission tube is activated; and
one or more trigger doors pivotally coupled to the housing proximate the entrance to the inspection chamber, each trigger door of the one or more trigger doors being configured for pivotal movement about and between a closed position and an open position,
wherein, upon contact between the one or more trigger doors and the article, each trigger door of the one or more trigger doors is configured to move to the open position, and
wherein at least one trigger door of the one or more trigger doors is shaped to trigger the sensor when the one or more trigger doors are positioned in the open position, thereby activating the X-ray emission tube.

2. The X-ray inspection device of claim 1, wherein the sensor is a photoelectric eye switch.

3. The X-ray inspection device of claim 1, wherein the sensor has a detection zone, wherein the sensor is configured to detect the presence of an article within the detection zone, and wherein, in the open position, at least a portion of at least one trigger door of the one or more trigger doors is positioned within the detection zone.

4. The X-ray inspection device of claim 4, wherein the entrance to the inspection chamber is defined by opposed first and second side portions of the housing and a top portion of the housing extending between the first and second side portions.

5. The X-ray inspection device of claim 4, wherein the one or more trigger doors comprises a single trigger door secured to the top portion of the housing.

6. The X-ray inspection device of claim 4, wherein the one or more trigger doors comprises a single trigger door secured to one of the first and second side portions of the housing.

7. The X-ray inspection device of claim 1, wherein the one or more trigger doors comprises opposed first and second trigger doors respectively secured to the opposed first and second side portions of the housing.

8. The X-ray inspection device of claim 1, wherein the one or more trigger doors are hingedly attached to the housing.

9. The X-ray inspection device of claim 8, wherein, during movement from the closed position to the open position, the one or more trigger doors are configured to open inwardly in the direction of movement of the article relative to the transport axis.

10. The X-ray inspection device of claim 1, wherein the one or more trigger doors are biased to return to the closed position.

11. The X-ray inspection device of claim 1, wherein the one or more trigger doors are shaped to substantially fill the entrance to the inspection chamber of the housing.

12. A trigger door assembly for triggering a sensor of an X-ray inspection device during inspection of an article, the X-ray inspection device having a housing defining an inspection chamber defining an entrance and an exit, and an X-ray emission tube operatively coupled to the sensor, the sensor being configured to detect the presence of the article within the inspection chamber, the trigger door assembly comprising:
one or more trigger doors, each trigger door of the one or more trigger doors being configured for pivotal coupling to the housing of the X-ray inspection device proximate the entrance to the inspection chamber,
wherein each trigger door of the one or more trigger doors is configured for pivotal movement about and between a closed position and an open position,
wherein, upon contact between the one or more trigger doors and the article, each trigger door of the one or more trigger doors is configured to move to the open position, and
wherein at least one trigger door of the one or more trigger doors is shaped to trigger the sensor when the one or more trigger doors are positioned in the open position, thereby activating the X-ray emission tube.

13. The trigger door assembly of claim 12, wherein the one or more trigger doors comprises a single trigger door, and wherein the single trigger door is configured to be pivotally coupled to a top portion of the housing.

14. The trigger door assembly of claim 12, wherein the one or more trigger doors comprises a single trigger door, and wherein the single trigger door is configured to be pivotally coupled to a side portion of the housing.

15. The trigger door assembly of claim 12, wherein the one or more trigger doors comprises opposed first and second trigger doors, and wherein the first and second trigger doors are configured to be pivotally coupled to opposing first and second side portions of the housing.

16. The trigger door assembly of claim 12, wherein the one or more trigger doors comprise respective hinges, and wherein the hinges of the one or more trigger doors are configured to pivotally couple the one or more trigger doors to the housing.

17. The trigger door assembly of claim 12, wherein the article is configured for movement relative to a transport axis, and wherein, during movement from the closed position to the open position, the one or more trigger doors are configured to open inwardly in the direction of movement of the article relative to the transport axis.

18. The trigger door assembly of claim 12, wherein the one or more trigger doors are configured to be biased to return to the closed position.

19. A method of inspecting the contents of an article using an X-ray inspection device, comprising:
positioning the article on a conveyor belt, the conveyor belt configured for movement relative to a transport axis, a portion of the conveyor belt being positioned within an inspection chamber defined by a housing of the X-ray inspection device, the housing having a longitudinal axis, the conveyor belt being positioned within the inspection chamber such that the transport axis is substantially parallel to the longitudinal axis of the housing, the X-ray inspection device having one or more trigger doors pivotally coupled to the housing proximate an entrance to the inspection chamber, each trigger door of the one or more trigger doors being configured for pivotal movement about and between a closed position and an open position; and
selectively activating the conveyor belt such that the article is transported relative to the transport axis, wherein the article is transported relative to the transport axis such that the article contacts and passes through the one or more trigger doors,
wherein each trigger door of the one or more trigger doors is configured to move to the open position as the article contacts and passes through the one or more trigger doors,
wherein, in the open position, at least one trigger door of the one or more trigger doors is shaped to trigger a sensor of the X-ray inspection device when the one or more trigger doors are positioned in the open position, the sensor being operatively coupled to an the X-ray emission tube of the X-ray inspection device and configured to detect the presence of the article within the inspection chamber, and
wherein, upon triggering of the sensor, the X-ray emission tube is activated.

20. The method of claim 19, further comprising generating an X-ray image of the article.
